(19) United States
(12) Patent Application Publication
(10) Pub. No.: US 2014/0071460 A1
(43) Pub. Date: Mar. 13, 2014

(54) POSITIONING APPARATUS AND MEASURING APPARATUS

(71) Applicant: Canon Kabushiki Kaisha, Tokyo (JP)

(72) Inventor: Takeshi Suzuki, Utsunomiya-shi (JP)

(73) Assignee: CANON KABUSHIKI KAISHA, Tokyo (JP)

(21) Appl. No.: 13/958,783

(22) Filed: Aug. 5, 2013

(30) Foreign Application Priority Data
Sep. 11, 2012 (JP) 2012-199919

(51) Int. Cl. G01B 5/008; G01B 11/00

(52) U.S. Cl. CPC G01B 5/008; G01B 11/005
USPC 356/614; 33/503

(57) ABSTRACT

A positioning apparatus includes a structure including a movable portion, and a driving unit configured to drive the movable portion, and a control unit configured to control the driving unit. The control unit obtains data of a natural frequency of the structure, that changes in accordance with a state of at least one of a position and an attitude of the movable portion, using data of plural states of at least one of the position and the attitude of the movable portion, and controls the driving unit to reduce natural vibration with the changing natural frequency of the structure using the obtained data of the changing natural frequency of the structure.

### BACKGROUND OF THE INVENTION

1. Field of the Invention

The present invention relates to a positioning apparatus, and a measuring apparatus including the same.

2. Description of the Related Art

Positioning apparatuses are used in various fields such as conveyance, processing, and measurement, and a variety of positioning apparatuses have been proposed. A positioning apparatus generally includes a movable portion, a driving unit which generates a force to act on the movable portion, a measuring unit which measures the position or angle of the movable portion, and a control unit which controls the force generated by the driving unit. The positioning apparatus allows multi-degree-of-freedom positioning as it includes a plurality of units, depending on the circumstances involved. A practical example of a positioning apparatus which performs multi-degree-of-freedom positioning includes a three-dimensional measuring apparatus.

A three-dimensional measuring apparatus normally includes a base on which a work to be measured is mounted, a Y carriage, an X slider, and a Z spindle. The Y carriage has a gate structure, and the tops of a pair of legs are connected to each other via an X beam. Air bearing guides arranged on the two sides of the base support the bottoms of the pair of legs of the Y carriage to be movable in the Y-direction. An X slider is supported on the X beam to be movable in the X-direction through the air bearing guides. A Z spindle is supported on the X slider to be movable in the Z-direction through the air bearing guides. A probe is disposed on the bottom of the Z spindle, and movably supported in an X-Y-Z three-dimensional space with the above-mentioned configuration.

A driving mechanism which drives the Y carriage in the Y-direction generates a driving force to act from the base to one of the legs of the Y carriage. A driving mechanism which drives the X slider in the X-direction generates a driving force to act from the Y carriage to the X slider. A driving mechanism which drives the Z spindle in the Z-direction generates a driving force to act from the X slider to the Z spindle.

To read the X-, Y-, and Z-position coordinates of the probe, a Y-coordinate measurement linear scale is disposed on the base near the bottom of the leg on the side of the driving unit for the Y carriage, an X-coordinate measurement linear scale is disposed on the X beam, and a Z-coordinate measurement linear scale is disposed on the Z spindle. A contact probe is commonly used as the above-mentioned probe, so upon control of a contact force that acts between an object to be measured and the contacting sphere of the distal end of the contact probe, the probe position coordinates upon contact are read by the linear scales to measure the shape of the object to be measured.

Japanese Patent Laid-Open No. 6-114762 proposes a positioning apparatus and three-dimensional measuring apparatus which set a jerk corresponding to the natural frequency to reduce vibration. According to Japanese Patent Laid-Open No. 6-114762, natural vibration can be reduced by multiplying the jerk time (the time for the acceleration to change) by an integer multiple of the natural period of the object to be driven. Also, in recent years, a non-contact probe which measures the distance to an object to be measured using light is widely used. WO00/09993 and Japanese Patent Laid-Open No. 2004-333369 each propose a non-contact probe including an optical scanning mechanism including a rotary motor.

However, in three-dimensional measuring apparatuses described in Japanese Patent Laid-Open No. 6-114762, WO00/09993, and Japanese Patent Laid-Open No. 2004-333369, the natural frequency changes depending on the position of each axis. For example, the natural frequency of the apparatus changes from several ten to several hundred hertz in a case wherein the Z spindle is positioned at the lowermost end of the movable range, and that wherein it is positioned at the uppermost end of the movable range. The natural frequency of the apparatus also changes depending on the attitude of the probe at the distal end of the Z spindle. Therefore, even when an acceleration time and a jerk time are set in accordance with the natural frequency at a certain position, they are not suitable for other positions, and natural vibration is often excited.

When the non-contact probe includes a scanning mechanism such as a galvanomirror, its driving frequency must be set so as not to excite vibration with the natural frequency of the three-dimensional measuring apparatus. Even when the driving frequency does not overlap the natural frequency of the apparatus in the state where the apparatus is at a certain position or in a certain state, the natural frequency of the apparatus changes as the apparatus position or state varies. Therefore, when the apparatus position or state changes, the natural frequency of the apparatus and the driving frequency of the scanning mechanism may overlap each other, so the apparatus often resonates, thus degrading the measurement accuracy. Also, when the driving frequency of the scanning mechanism is set too low relative to the natural frequency of the apparatus to avoid resonance of the apparatus, the measurement time often becomes long.

### SUMMARY OF THE INVENTION

The present invention provides a positioning apparatus capable of rapid positioning with high accuracy even when the natural frequency of a structure which constitutes the apparatus changes.

The present invention provides a positioning apparatus including a structure including a movable portion, and a driving unit configured to drive the movable portion, and a control unit configured to control the driving unit, wherein the control unit obtains data of a natural frequency of the structure, that changes in accordance with a state of at least one of a position and an attitude of the movable portion, using data of plural states of at least one of the position and the attitude of the movable portion, and controls the driving unit to reduce natural vibration with the changing natural frequency of the structure using the obtained data of the changing natural frequency of the structure.

Further features of the present invention will become apparent from the following description of exemplary embodiments with reference to the attached drawings.

### BRIEF DESCRIPTION OF THE DRAWINGS

FIG. 1 is a view showing a three-dimensional measuring apparatus in the first embodiment;

FIG. 2 is a flowchart of a measuring procedure in the first embodiment;

FIGS. 3A and 3B are graphs showing acceleration profiles in the first embodiment;

FIG. 4 is a view showing a non-contact probe in the second embodiment;

FIG. 5 is a flowchart of a measuring procedure in the second embodiment; and

FIGS. 6A and 6B are graphs showing various profiles in the second embodiment.

### DESCRIPTION OF THE EMBODIMENTS

Embodiments of the present invention will be described in detail below with reference to the accompanying drawings.

### First Embodiment

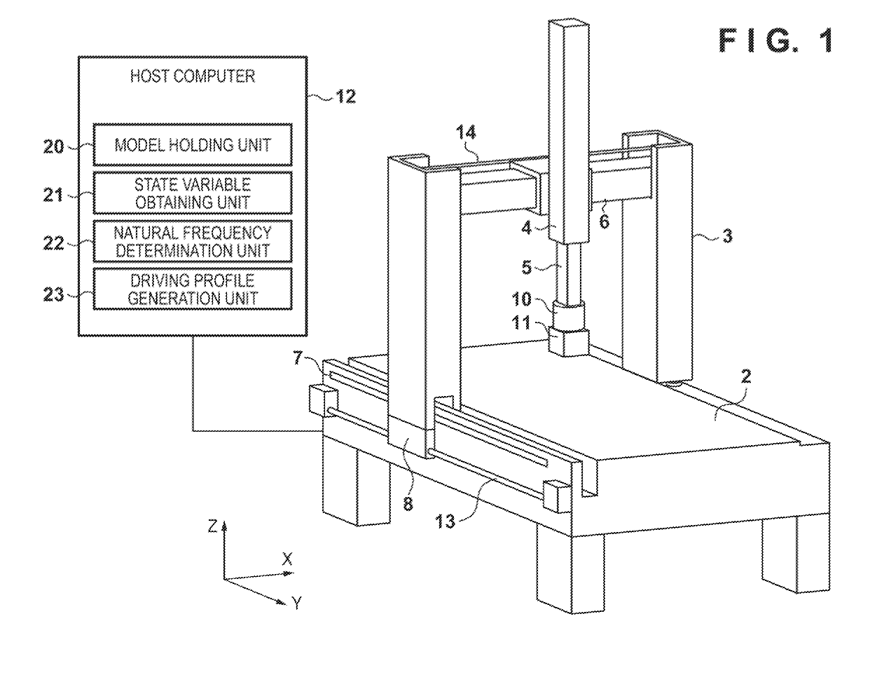

FIG. 1 shows a three-dimensional measuring apparatus (measuring apparatus) including a contact probe in the first embodiment. A three-axis driving stage (positioning apparatus) for positioning the contact probe in the measuring apparatus includes a base 2 on which an object to be measured is mounted, a Y carriage 3, an X slider 4, and a Z spindle 5. The Y carriage 3 has a gate structure, and the tops of a pair of legs are connected to each other via an X beam 6. Air guides arranged on the two sides of the base 2 support the bottoms of the pair of legs of the Y carriage 3 to be movable in the Y-direction.

The X slider 4 is supported on the X beam 6, which connects the upper ends of the Y carriage 3 to each other, to be movable in the X-direction through an air guide. The Z spindle 5 is supported on the X slider 4 to be movable in the Z-direction through an air guide. A contact probe 11 held at the top of a biaxial rotary head 10 disposed at the bottom of the Z spindle 5 is movable in three axial directions, that is, the X-, Y-, and Z-directions. The Y carriage 3, X slider 4, Z spindle 5, and biaxial rotary head, for example, constitute a movable portion.

To read the X-, Y-, and Z-coordinates of the probe 11, a Y-coordinate measurement linear encoder 7 is disposed near the leg of the Y carriage 3, an X-coordinate measurement linear encoder (not shown) is disposed on the X beam 6, and a Z-coordinate measurement linear encoder (not shown) is disposed on the Z spindle 5. A driving unit for driving the Y carriage 3 in the Y-direction includes a Y shaft 13 disposed on the base 2, and a Y movable portion 8 disposed on the Y carriage 3. The driving unit moves one of the legs of the Y carriage 3 to move the Y carriage 3 having a gate structure in the Y-direction. A driving unit for moving the X slider 4 in the X-direction includes an X shaft 14 disposed on the Y carriage 3, and an X movable portion (not shown) disposed on the X slider 4.

A driving unit for moving the Z spindle 5 in the Z-direction includes a Z shaft (not shown) disposed on the X slider 4, and a Z movable portion (not shown) disposed on the Z spindle 5. The biaxial rotary head 10 which is disposed at the distal end of the Z spindle 5, and used to change the attitude of the probe 11 can rotate about the Z-axis and rotation about the horizontal axis. A host computer (control unit) 12 issues control commands to the X, Y, and Z driving mechanisms, biaxial rotary head 10, and contact probe 11 to analyze each measurement value, and calculate the shape of the surface (surface to be measured) of the object to be measured. The movable portions including the Y carriage 3, X slider 4, Z spindle 5, and biaxial rotary head, and the driving units which drive them constitute a structure.

The host computer 12 includes a model holding unit 20, state variable obtaining unit 21, natural frequency determination unit 22, and driving profile generation unit 23. The model holding unit 20 has a model of the vibration state which defines the relationship between data (state variable) indicating the state of the positioning apparatus, and the natural frequency of the structure. The state variable includes at least one of the position and attitude of the measuring apparatus. The state variable obtaining unit 21 obtains a state variable. The natural frequency determination unit 22 determines a natural frequency by inputting a state variable into a model of the vibration state. The driving profile generation unit 23 generates a driving profile based on the determined natural frequency.

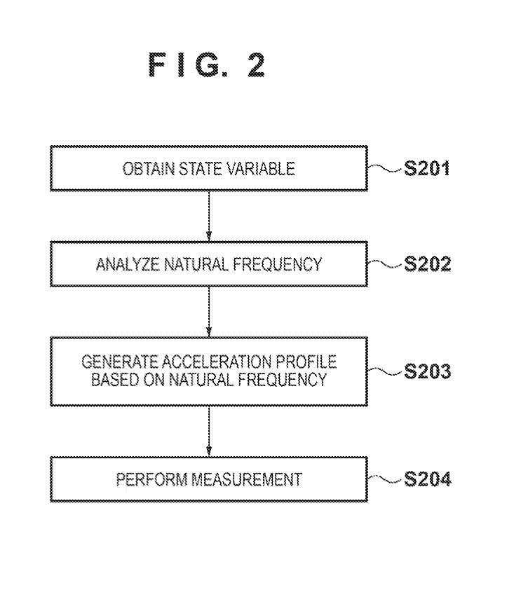

The measuring procedure of the measuring apparatus in the first embodiment will be described below with reference to FIG. 2. This measuring procedure reduces vibration generated by the measuring apparatus in acceleration/deceleration at the start and end of driving. More specifically, this procedure can be used for movement to the vicinity of the next measurement point in point measurement by a touch trigger, or scan driving in scanning measurement.

In step S201, the state variable obtaining unit 21 obtains a shift of the state variable of the measuring apparatus in the period in which the measuring apparatus measures the object to be measured. The state variable of the measuring apparatus includes, for example, data of the position of the Z spindle 5, which indicates the position of the contact probe 11, and data of the rotation angle of the biaxial rotary head 10, which indicates the attitude of the contact probe 11. The obtained shift of the state variable can be that of position data defined from a predesignated measurement start position to measurement end position obtained using the design information of the object to be measured. Also, the state variable obtaining unit 21 may obtain a shift of data of the state from the measurement result obtained when the object to be measured is measured in advance using the measuring apparatus.

In step S202, the natural frequency determination unit 22 analyzes the natural frequency of the measuring apparatus. As analysis methods of the natural frequency, the following three methods are available. In any of these methods, the model holding unit 20 holds a model of the vibration state, and the natural frequency determination unit 22 obtains a shift of the natural frequency by inputting a shift of the state variable obtained by the state variable obtaining unit 21 into a model of the vibration state.

<First Analysis Method for Natural Frequency>

In the first method, the entire structure of the measuring apparatus is modeled using a multi-degree-of-freedom spring-mass system model. For example, the structure of the measuring apparatus is divided into constituent elements such as the Z spindle 5 and X slider 4, and each constituent element is represented as a mass point having its mass, moment of inertia, and barycentric position as parameters. This representation is done by applying appropriate spring stiffnesses to an air pad and bonding portion. Each parameter need only be determined based on design information, and is more desirably determined by partially conducting vibration modal experiments, and performing identification so as to match transfer characteristics. Also, as for a member that can hardly be modeled by a rigid body using one constituent element as one mass point, it may be regarded as an elastic body in a pseudo manner by connecting a plurality of mass points using springs.

After the entire structure of the measuring apparatus is modeled using a multi-degree-of-freedom spring-mass system model, equations of motion of translation and rotation in six degrees of freedom for each mass point are established. For example, equations of motion for a mass point i are expressed as:

$${m}_{i} {\ddot{x}}_{i} + {\sum }_{j}^{ } {k}_{xij} ( {x}_{i} - {x}_{j} ) = 0 \\ {m}_{i} {\ddot{y}}_{i} + {\sum }_{j}^{ } {k}_{yij} ( {y}_{i} - {y}_{j} ) = 0 \\ {m}_{i} {\ddot{z}}_{i} + {\sum }_{j}^{ } {k}_{zij} ( {z}_{i} - {z}_{j} ) = 0 \\ {J}_{ω xi} {\ddot{θ}}_{ω xi} + {\sum }_{j}^{ } {k}_{ω xij} ( {θ}_{ω xi} - {θ}_{ω xj} ) = 0 \\ {J}_{ω yi} {\ddot{θ}}_{ω yi} + {\sum }_{j}^{ } {k}_{ω yij} ( {θ}_{ω yi} - {θ}_{ω yj} ) = 0 \\ {J}_{ω zi} {\ddot{θ}}_{ω zi} + {\sum }_{j}^{ } {k}_{ω yij} ( {θ}_{ω zi} - {θ}_{ω zj} ) = 0 \qquad ( 1 )$$

where mᵢ is the mass at the mass point i, kₓᵢⱼ, k_{yij}, and k_{zij} are the spring stiffnesses between the mass points i and j in respective translational directions, xᵢ, yᵢ, and zᵢ are the translational displacements of the mass point i in the X-, Y-, and Z-directions, J_{ωxi}, J_{ωyi}, and J_{ωzi} are the moments of inertia of the mass point i in respective rotation directions, k_{ωxij}, k_{ωyij}, and k_{ωzij} are the torsional spring stiffnesses between the mass points i and j in respective translational directions, and θ_{ωxi}, θ_{ωyi}, and θ_{ωzi} are the rotation angles of the mass point i. In this embodiment, since analysis is done to derive a natural frequency, damping terms which do not contribute to the result are not taken into consideration.

When equations of motion for all mass points are integrated as:

[M]{Ü}+[K]{U}=0 (2)

where [M] is a mass matrix, [K] is a stiffness matrix, and U is displacement and rotation vectors.

The solution of equation (2) results in an eigenvalue problem, and an eigenvalue ω and eigenvector {C} which satisfy:

ω²[M]{C}=[K]{C} (3)

are obtained to obtain a plurality of sets of the natural frequency and the natural vibration mode.

Of the plurality of obtained sets of the natural frequency and the natural vibration mode, a natural vibration mode that is easily excited by an acceleration profile to be generated is extracted. In, for example, a profile which moves in the X-direction, vibration in the X-direction is easily excited, but vibration in a perpendicular direction can hardly be excited, so natural vibration modes in the X-direction are selected. A natural frequency of a minimum order degree is selected from the selected natural vibration modes. This method is advantageous in terms of speeding up calculation by matrix calculation.

<Second Analysis Method for Natural Frequency>

Analysis which uses the FEM (Finite Element Method) is available as the second analysis method for the natural frequency. In this method, a natural frequency is obtained using the FEM while changing the position. While this method exhibits good calculation accuracy, a problem associated with the calculation time is posed, depending on the mesh conditions.

<Third Analysis Method for Natural Frequency>

In the third method, vibration modal experiments are conducted in each state within a moving space, and the position and natural frequency are associated with each other and tabulated. This method requires a long time to obtain a table, but nonetheless exhibits a highest accuracy of directly obtaining a natural frequency using an actual machine.

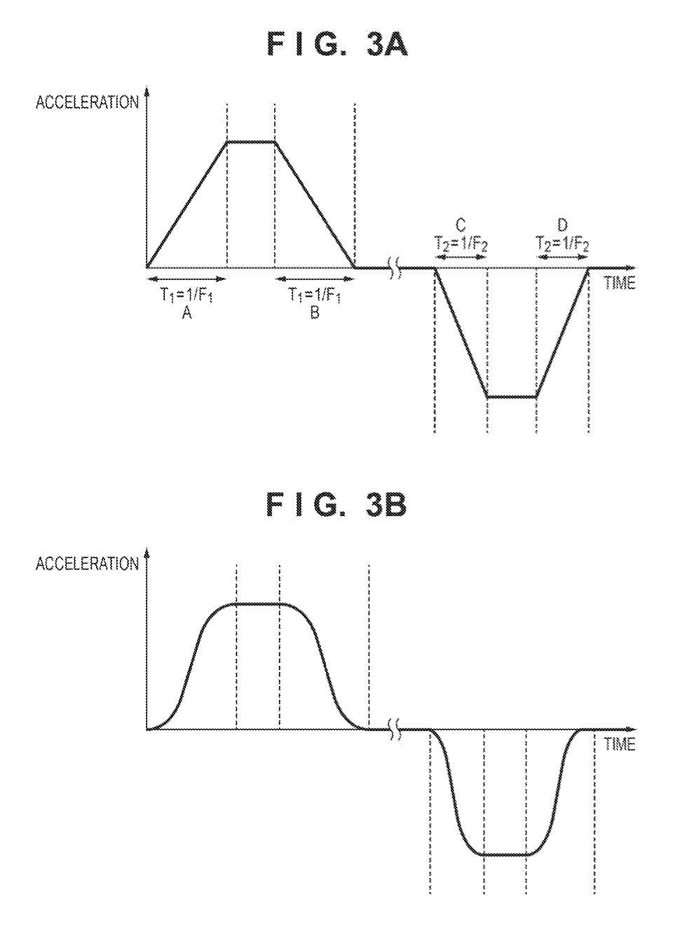

When the natural frequency changes depending on factors other than the position, such as the type and attitude of the contact probe 11, the factors other than the position need only be added to the state variable and analysis model. In step S203, the driving profile generation unit 23 generates an acceleration profile to reduce the shifting natural frequency obtained in step S202. FIGS. 3A and 3B illustrate examples of the acceleration profile. The acceleration profile has a first interval in which the acceleration of the movable portion stays constant, and a second interval (jerk interval) in which the acceleration changes.

Of the acceleration profiles, vibration is excited mainly when the acceleration mainly rapidly changes, that is, at the start and end times of the jerk interval. When the jerk interval is set to have a time corresponding to an integer multiple of the natural period, vibration excited at the start of a jerk, and that excited at the end of the jerk cancel each other in the first interval. Hence, in this embodiment, a jerk interval (second interval) is set to have a time corresponding to an integer multiple of the natural period obtained from the natural frequency.

As an example of the acceleration profile, a trapezoidal acceleration profile which changes the acceleration in the jerk interval at a constant jerk, shown in FIG. 3A, is available. Referring to FIG. 3A, a jerk time T1 common to jerk intervals A and B is set, while a jerk time T2 common to jerk intervals C and D is set. This setting is done when the influence of a change in natural frequency due to a change in position between the jerk intervals A and B and between the jerk intervals C and D is small. If the influence of a change in natural frequency due to a change in position is too large to ignore, jerk times need only be determined based on the natural frequencies at respective positions in the jerk intervals A to D. The trapezoidal acceleration profile corresponds to that obtained by applying, to a rectangular acceleration profile, a moving average which uses a time corresponding to an integer multiple of the natural period as a moving average time.

As another example of the acceleration profile, an S-shaped acceleration profile shown in FIG. 3B is available. The S-shaped acceleration profile is characterized in that the jerk interval has an S shape, and is superior in vibration damping effect to the trapezoidal acceleration profile as the acceleration changes smoothly. On the other hand, the S-shaped acceleration profile takes a higher maximum acceleration or a longer movement time. The S-shaped acceleration profile corresponds to that obtained by applying, to a rectangular acceleration profile, a moving average twice using a time corresponding to an integer multiple of the natural period as a moving average time. The rectangular acceleration profile, the moving average of which is to be calculated, is a rectangular profile having one side that shows a constant acceleration in the first interval. By setting the moving average times of two moving averages to be applied as an integer multiple of one natural period, a vibration reduction effect on the selected natural period increases, and high-frequency vibration can hardly be excited. Also, different natural periods may be selected for the moving average times of two moving average filters to be applied. In this case, a vibration reduction effect can be obtained for each natural period, so high-frequency vibration can hardly be excited.

As still another example of the acceleration profile, an acceleration cosine profile and acceleration cosine squared profile are available. Let α be the acceleration in the jerk interval (second interval), Ti be the natural period, t be time, (π/Ti)=ω₀, and A be a constant. Then, the acceleration cosine profile and acceleration cosine squared profile have accelerations a in the jerk interval as:

α=A×(1−cos(ω₀t))/2 (4)

α=A×(1−cos(ω₀t))²/2 (5)

In the acceleration cosine profile and acceleration cosine squared profile, the acceleration smoothly changes in the jerk interval in almost the same way as the S-shaped acceleration profile shown in FIG. 3B. However, since the jerk interval includes only one spectrum corresponding to ω₀, other natural frequencies can hardly be excited, so the vibration damping effect is high.

In step S204, the driving units for the Y carriage 3, X slider 4, and Z spindle 5 drive the Y carriage 3, X slider 4, and Z spindle 5, respectively, in accordance with the acceleration profile obtained in step S203 to perform, for example, point measurement by a touch trigger, or scanning measurement.

### Second Embodiment

The basic configuration of a measuring apparatus in the second embodiment is the same as that of the measuring apparatus in the first embodiment, but is different in that it includes a non-contact probe 11′ in place of the contact probe 11. The non-contact probe 11′ includes a scanning unit 402 which scans, on the surface of an object to be measured 408, measurement light emitted by a light source 403, and a detector 409 which detects the measurement light reflected by the object to be measured 408. The scanning unit 402 includes a galvanomirror 407 which reflects, toward the object to be measured 408, measurement light emitted by the light source 403, and a rotation driving unit 407′ which rotates the galvanomirror 407. By scanning the non-contact probe 11′ in the tangential direction to the surface of the object to be measured 408, and a direction perpendicular to galvano-scanning, the measuring apparatus performs scanning measurement of the surface of the object to be measured 408.

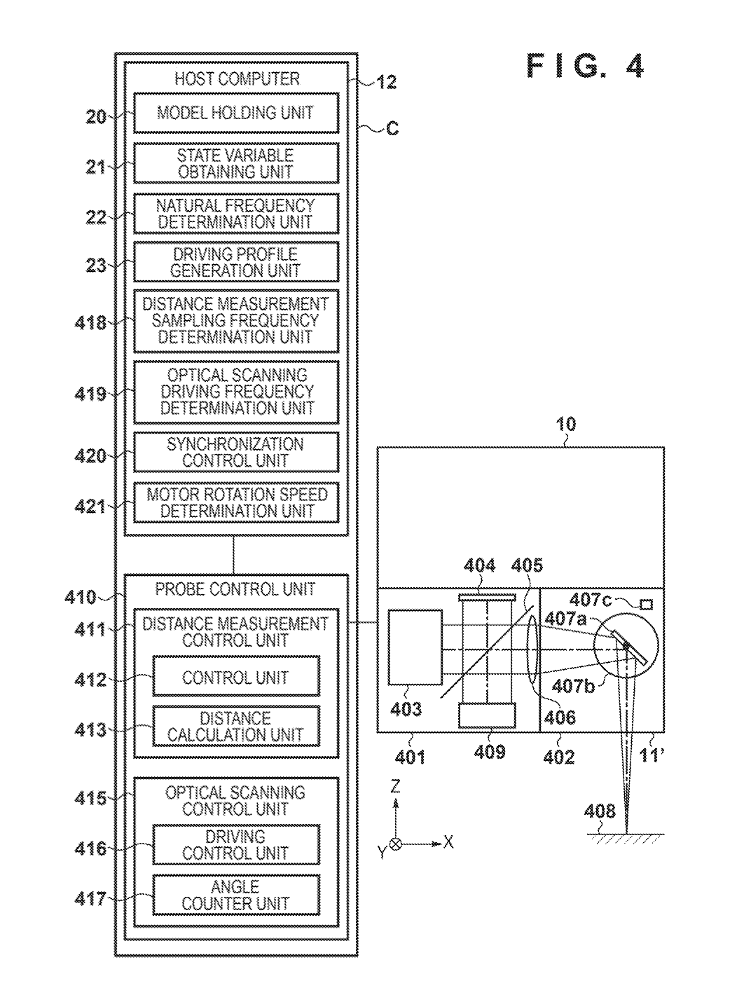

As shown in FIG. 4, a certain component of laser light emitted by the light source 403 is transmitted through a half mirror 405, and enters the scanning unit 402 upon being condensed by a condenser lens 406. The laser light incident on the scanning unit 402 is reflected by a galvanomirror 407a, and reaches the object to be measured 408. A certain component of the laser light reflected on the object to be measured 408 travels back through almost the same optical path, is reflected by the half mirror 405, and enters the light receiving unit (detector) 409. On the other hand, a certain component of the laser light reflected by the half mirror 405 is reflected by a reference mirror 404, is transmitted through the half mirror 405, and enters the light receiving unit 409. An interference signal generated by two light beams is detected by the light receiving unit 409, and converted into a distance in the optical axis direction by a distance calculation unit 413. Although a Michelson optical measuring unit 401 is used in this embodiment, the present invention is not limited to this, and an optical measuring unit of another interference type, such as the homodyne or heterodyne type, may be applied. Alternatively, other types which do not use interference, such as the triangulation distance measurement type, may be applied.

A probe control unit 410 includes a distance measurement control unit 411 and optical scanning control unit 415. The distance measurement control unit 411 includes a control unit 412 which controls the light amount and wavelength of the light source 403, and the distance measurement timing, and the distance calculation unit 413 which calculates the distance from the amount of received light. Also, the optical scanning control unit 415 includes a driving control unit 416 which performs driving control of a galvanomotor 407b, and an angle counter unit 417 which measures the angle of the galvanomirror 407a using an encoder 407c attached to the galvanomotor 407b. A host computer 12 which controls the main body of the measuring apparatus additionally includes an optical scanning driving frequency determination unit 419, distance measurement sampling frequency determination unit 418, and synchronization control unit 420. The optical scanning driving frequency determination unit 419 determines the driving frequency of optical scanning based on a natural frequency determined by a natural frequency determination unit 22. The distance measurement sampling frequency determination unit 418 determines the sampling frequency of distance measurement based on the driving frequency of optical scanning. The synchronization control unit 420 controls all synchronization operations such as distance measurement, optical scanning, and position measurement of the measuring apparatus. The host computer 12, probe control unit 410, and optical scanning control unit 415 constitute a control unit.

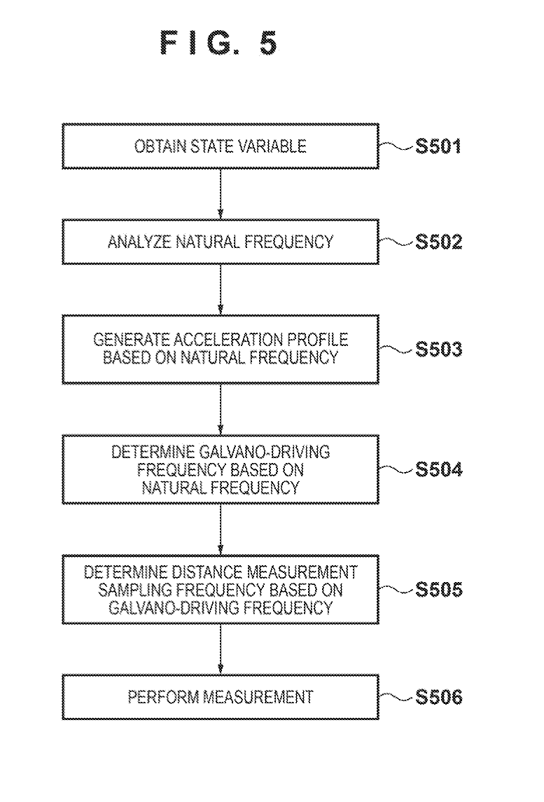

The measuring procedure of the measuring apparatus in the second embodiment will be described below with reference to FIG. 5. This measuring procedure can be used when vibration during scan driving in scanning measurement is reduced. In step S501, a state variable obtaining unit 21 obtains the state variable of the measuring apparatus, for example, the position information of the non-contact probe 11′. In step S502, the natural frequency determination unit 22 analyzes the natural frequency of the structure. Step S502 is the same as step S202 in the measuring procedure described in the first embodiment.

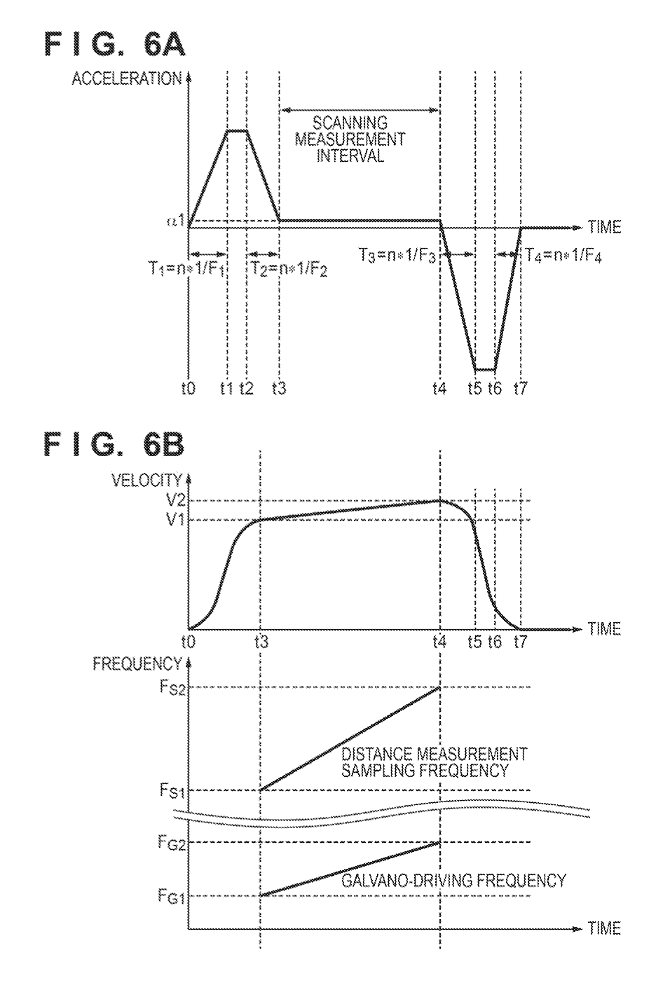

In step S503, a driving profile generation unit 23 generates an acceleration profile in accordance with the natural frequency obtained in step S502. Step S503 is the same as step S203 in the measuring procedure described in the first embodiment. In step S503, profiles in intervals other than the jerk intervals of the start and end of driving are also generated in accordance with the natural frequency. Details will be described later with reference to FIGS. 6A and 6B.

In step S504, the optical scanning driving frequency determination unit 419 determines a galvano-driving frequency which does not excite natural vibration, based on the natural frequency at each position obtained in step S502. If, for example, the natural frequency of the measuring apparatus is obtained as F1 at a certain position, natural vibration can be made hard to excite by separating a galvano-driving frequency F_{G} from each other by twice or three or more times F1. Further, when F_{G} is selected to be a noninteger multiple such as 2.5 or 3.5 to avoid setting F_{G} and F1 in a relationship of an integer multiple, excitation of natural vibration by a high- or low-frequency wave can be reduced.

In step S505, the distance measurement sampling frequency determination unit 418 determines the sampling frequency of distance measurement, based on the galvano-driving frequency at each position obtained in step S504. An inter-measurement point pitch 5P to be obtained on the surface of the object to be measured 408 is expressed using a basic galvano-driving frequency F_{GB} and a basic distance measurement sampling frequency F_{SB} as per:

δP=D×(F_{GB}/F_{SB}) (6)

Then, a predetermined inter-measurement point pitch can be obtained on the surface of the object to be measured 408 when a distance measurement sampling frequency F_{S} is determined to satisfy:

F_{S}=F_{G}×(F_{SB}/F_{GB}) (7)

that is, to be proportional to the galvano-driving frequency F_{G} determined in step S504.

In step S506, the synchronization control unit 420 performs scanning measurement by synchronously operating each unit in accordance with the acceleration profile, galvano-driving frequency, and distance measurement sampling frequency determined in steps S503 to S505, respectively.

FIGS. 6A and 6B illustrate examples of the driving profiles of scanning measurement. Let F1 be the natural frequency at the driving start position, F2 be the natural frequency at the scanning measurement start position, F3 be the natural frequency at the scanning measurement end position, and F4 be the natural frequency at the stop position. Also, the natural frequency is assumed to change linearly in the interval from the scanning measurement start position to the scanning measurement end position. Time t₀ to time t₁ and time t₂ to time t₃ are the jerk intervals at the time of acceleration, time t₁ to time t₂ are the constant acceleration interval at the time of acceleration, time t₃ to time t₄ are the scanning measurement interval, time t₄ to time t₅ and time t₆ to time t₇ are the jerk intervals at the time of deceleration, and time t₅ to time t₆ are the constant acceleration interval at the time of deceleration. In each jerk interval, the reciprocals of the natural frequencies at the respective positions, that is, integer multiples of the natural periods at the respective positions are defined as jerk times T1, T2, T3, and T4. This reduces natural vibration due to factors associated with acceleration/deceleration at each position. Also, in the interval from time t₃ to time t₄ in which the natural frequency changes linearly, the galvano-driving frequency F_{G} and distance measurement sampling frequency F_{S} are continuously changed in accordance with a change in natural frequency to satisfy:

F_{G}/F_{S}=F_{G1}/F_{S1}=F_{G2}/F_{S2}=const (8)

Further, in the same interval, scanning measurement is performed with acceleration by applying an acceleration α1 to satisfy:

F_{G}/V=F_{G1}/V₁=F_{G2}/V₂=const (9)

Scanning measurement can be done in a short time by performing the measurement with acceleration to avoid vibration at the time of acceleration/deceleration or resonance upon galvano-driving in the jerk interval using profiles as mentioned above. Also, the inter-point pitch in the galvano-scanning direction is always constant on the surface of the object to be measured 408, and a predetermined scanning trace can always be obtained in a direction perpendicular to the galvano-scanning direction as well, so necessary and sufficient measurement points can be obtained. That is, required scanning measurement can be performed in a short time without degrading the measurement accuracy due to natural vibration.

In the above-mentioned example, excitation of natural vibration is suppressed by adjusting the driving frequency of the galvanomotor 407b of the non-contact probe 11′ to fall outside the natural frequency of the structure. This example is applicable to other types of rotary motors. When, for example, a feed screw mechanism is used as a driving mechanism for an X-Y-Z translational stage, vibration of the rotary motor may excite natural vibration. Also, a fan motor is used for, for example, air conditioning of a chamber, and heat exhaust of an electrical rack, rotation vibration or sound of the fan motor may excite natural vibration of the structure. To avoid this problem, a motor rotation speed determination unit 421 need only be provided to determine a motor rotation speed, that does not excite natural vibration, based on natural vibration from the analysis result of the natural frequency. A method of determining a motor rotation speed can be used in the same way as in that of determining a galvano-driving frequency F_{G}, so a motor rotation speed need only be determined so that the natural frequency and the motor rotation speed separate from each other by twice or three or more times, and eventually, have a relationship of a noninteger multiple.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-199919, filed Sep. 11, 2012, which is hereby incorporated by reference herein in its entirety.

What is claimed is:

1. A positioning apparatus including a structure including a movable portion, and a driving unit configured to drive the movable portion, and a control unit configured to control the driving unit, wherein
the control unit
obtains data of a natural frequency of the structure, that changes in accordance with a state of at least one of a position and an attitude of the movable portion, using data of plural states of at least one of the position and the attitude of the movable portion, and
controls the driving unit to reduce natural vibration with the changing natural frequency of the structure using the obtained data of the changing natural frequency of the structure.

2. The apparatus according to claim 1, wherein the control unit
has a model which defines a relationship between the state of at least one of the position and the attitude of the movable portion, and the natural frequency of the structure, that changes in accordance with the state, and
obtains data of the changing state in a period in which the driving unit drives the movable portion, inputs data of the changing state into the model to obtain a shift of the natural frequency of the structure, and controls the driving unit to reduce natural vibration with the changing natural frequency of the structure.

3. The apparatus according to claim 1, wherein the control unit controls the driving unit to reduce natural vibration of a natural frequency of a minimum order degree among a plurality of natural frequencies.

4. The apparatus according to claim 1, wherein
the control unit generates an acceleration profile of the movable portion based on the changing natural frequency, and controls the driving unit based on the acceleration profile, and
the acceleration profile has a first interval in which an acceleration of the movable portion is constant, and a second interval in which the acceleration changes and has a time corresponding to an integer multiple of a natural period obtained from the natural frequency.

5. The apparatus according to claim 4, wherein the control unit changes the acceleration in the second interval at a constant jerk.

6. The apparatus according to claim 4, wherein the control unit obtains the acceleration in the second interval by applying, twice, a moving average to a rectangular acceleration profile having one side that shows a constant acceleration in the first interval using a time corresponding to an integer multiple of the natural period as a moving average time.

7. The apparatus according to claim 4, wherein the control unit determines the acceleration a in the second interval as one of:
α=A×(1−cos(ω₀t))/2 and α=A×(1−cos(ω₀t))²/2
where Ti is the natural period, t is time, (n/Ti)=ω₀, and A is a constant.

8. The apparatus according to claim 2, wherein the model includes a spring-mass system model.

9. The apparatus according to claim 1, wherein
the driving unit includes a rotary motor, and
the control unit controls a rotation speed of said rotary motor to reduce natural vibration with the changing natural frequency of the structure.

10. A measuring apparatus of measuring a shape of a surface to be measured by moving a probe relative to the surface to be measured, the apparatus comprising:
a positioning apparatus configured to position the probe,
said positioning apparatus including
a structure including a movable portion, and a driving unit configured to drive said movable portion, and a control unit configured to control said driving unit,
wherein said control unit
obtains data of a natural frequency of the structure, that changes in accordance with a state of at least one of a position and an attitude of the movable portion, using data of plural states of at least one of the position and the attitude of the movable portion, and
controls the driving unit to reduce natural vibration with the changing natural frequency of the structure using the obtained data of the changing natural frequency of the structure.

11. The apparatus according to claim 10, wherein said control unit obtains data of the changing state from one of design information of the surface to be measured, and a measurement result obtained by measuring, in advance, the surface to be measured using the measuring apparatus.

12. The apparatus according to claim 10, wherein the probe includes a contact probe moved in contact with the surface to be measured.

13. The apparatus according to claim 10, wherein
the probe includes a non-contact probe including a scanning unit configured to scan, on the surface to be measured, measurement light emitted by a light source, and a detector configured to detect the measurement light reflected by the surface to be measured,
said scanning unit includes a galvanomirror which reflects, toward the surface to be measured, the measurement light emitted by the light source, and a rotation driving unit configured to rotate said galvanomirror, and
said control unit controls said rotation driving unit to reduce natural vibration with the changing natural frequency of the structure.

14. The apparatus according to claim 13, wherein said control unit determines a sampling frequency of detection by said detector to be proportional to a driving frequency of said rotation driving unit.
